(19) United States
(12) Patent Application Publication
(10) Pub. No.: US 2003/0206136 A1
(43) Pub. Date: Nov. 6, 2003

(54) Inverted-F antenna

(76) Inventor: Po-Chao Chen, Taipei (TW)

Correspondence Address: BIRCH STEWART KOLASCH & BIRCH, PO BOX 747, FALLS CHURCH, VA, 22040-0747, US

(21) Appl. No.: 10/136,289

(22) Filed: May 2, 2002

(51) Int. Cl. H01Q 1/24

(52) U.S. Cl. 343/702

(57) ABSTRACT

An inverted-F antenna is disclosed. Due to the limited space in notebook computers, the invention utilizes the design of an inverted-F antenna to compute the path length of a dual-band or triple-band antenna open end, thereby designing a dual-band inverted-F antenna. The path length from the open end to the signal feed end is exactly ¼ of the wavelength of the waves that the antenna emits. For antennas of different frequencies, the path lengths also vary.

### BACKGROUND OF THE INVENTION

1. Field of Invention

The invention relates to an antenna and, in particular, to a dual-band inverted-F antenna for notebook computers.

2. Related Art

It is currently a trend to minimize communication products such as mobile phones. Furthermore, the communication products start to integrate with other electronics to enrich their functions. For example, communication devices are often installed in notebook computers or PDA's (Personal Digital Assistant). In these cases, it is necessary to make the communication devices as small as possible. What is even more ambitious is that the Bluetooth and wireless LAN technologies promise to integrate the communication devices with all kinds of electronic devices. Accordingly, the development of the Bluetooth technology definitely will push the miniaturization of communication products to the climax.

An important factor must be taken into account in the communication technology development, namely, the antenna. As communication devices get smaller, the antenna must become smaller in size too. It is already a mature field in the prior art to provide solutions in minimizing antennas. For instance, the micro-stripe antenna (thin antenna), the inverted-F antenna, the high dielectric antenna, antennas embedded into gaps and small spiral antennas are the examples in this trend of minimizing antennas.

Moreover, to increase the bandwidth the frequency range of the communication devices become wider and even higher. Taking the Bluetooth technology as an example, its base frequency is 2.4 GHz. GSM adopts the 1.8 GHz for base frequency. As the frequency gets higher, the antenna has to be smaller.

In response to the wide bandwidth, researchers make dual-band or even multi-band communication devices important objects of their researches in order for a single communication device to be able to work at different channels. Among various solutions, how to make a miniaturized antenna to have dual-band or multi-band work frequencies is now the main subject under studies.

For portable electronic devices such as notebook computers, they have a lot of metal structures that form electromagnetic interference (EMI) shielding to reflect antenna radiation. Therefore, one has to carefully consider many factors when designing a built-in antenna for notebook computers. It is completely different from and more difficult than designing an antenna in a free space, e.g. the frequency, characteristics, field, etc. Consequently, it is more difficult to design dual- or multi-band built-in antennas for notebook computers.

### SUMMARY OF THE INVENTION

The object of the invention is to provide an inverted-F antenna for notebook computers. The antenna can be a dual- or multi-band antenna according to practical needs.

To achieve the above object, the disclosed inverted-F antenna is used in notebook computers for receiving and transmitting radio signals. It is designed according to the radiation boundary of the notebook computer. The antenna includes: a feed end connected to a signal source that feeds in two voltage signals, a short end connected to a ground for outputting the two voltage signals to the ground, and two radiation paths each with one open end. The path length is determined according to the frequency of the two voltage signals and spans from the feed end to the two open ends, for radiating the two voltage signals from the two radiation paths and receiving two electromagnetic waves of the corresponding frequency. The two voltage signals are sent back to the ground through the short end.

In addition, the invention further provides a triple-frequency inverted-F antenna, which utilizes the same principle implemented in notebook computers.

### BRIEF DESCRIPTION OF THE DRAWINGS

The invention will become more fully understood from the detailed description given hereinbelow illustration only, and thus are not limitative of the present invention, and wherein:

FIG. 1 is a first embodiment of the disclosed dual-band inverted-F antenna;

FIG. 2 is a second embodiment of the disclosed dual-band inverted-F antenna;

FIG. 3 is a third embodiment of the disclosed dual-band inverted-F antenna; and

FIG. 4 is a first embodiment of the disclosed triple-band inverted-F antenna.

### DETAILED DESCRIPTION OF THE INVENTION

An inverted-F antenna is employed in order for portable electronic devices such as notebook computers to have a built-in antenna with more than two frequencies.

Since the notebook computer has limited space for built-in antennas, the size of the antenna has to be restricted by the desired radiation field magnitude and orientation. As the notebook computer becomes more compact and lighter, the only possible place left for the built-in antenna is thus the boundary space. Therefore, the antenna has to be thin and long in shape.

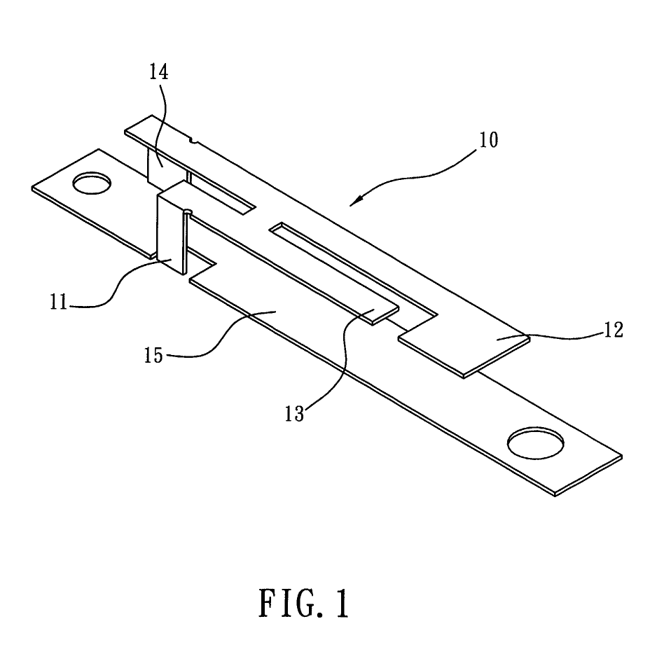

In the following paragraphs, the invention provides embodiments to explain the disclosed inverted-F antenna with more than one frequency. With reference to FIG. 1, the first embodiment of the invention uses two frequencies as radiation frequencies, namely 2.4 GHz and 5.2 GHz. The inverted-F antenna 10 contains a feed end 11, a first open end 12, a second open end 13, a short end 14 and a ground 15. The feed end 11 is the connecting point for the signal line. A high frequency signal (voltage) is transmitted from the feed end 11 to the first open end 12 and the second open end 13. The short end 14 is connected to the ground 15. The signal is finally transmitted through the first open end 12 and the second open end 13 to the short end 14, then to the ground 15. In the design, the distance between the first open end 12 and the feed end 11 (path length) is ¼ the wavelength of the 2.4 GHz wave (12.5 cm), i.e. about 3˜4 cm. The distance from the second open end 13 to the feed end 11, on the other hand, is ¼ the wavelength of the 5.2 GHz wave (5.8 cm), i.e. about 1.5˜2 cm. Accordingly, when inputting voltage with the corresponding frequencies from the feed end 11, the 2.4 GHz waves are radiated through the first open end 12 and the 5.2 GHz waves through the second open end 13. Receiving electromagnetic waves with the same frequencies is exactly the reversed process from the above.

To increase the bandwidth of the antenna, the open end can have some wider portion to increase the resonance frequency range of the open end. As shown in FIG. 1, the invention has a wider shape at the open end 12 to broaden the bandwidth.

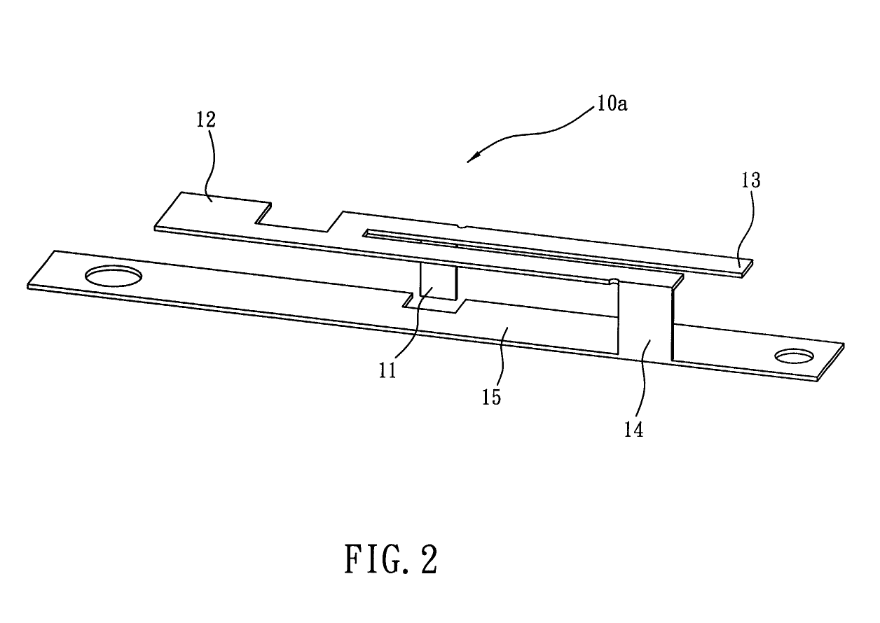

In fact, the shape given in FIG. 1 is one of the many possible solutions under the restrictions of long and thin space in notebook computers. With reference to FIG. 2, a second embodiment of the dual-band inverted-F antenna with 2.4 GHz and 5.2 GHz is illustrated. The path lengths are the same as in FIG. 1. The only difference is that the relative positions of the first open end and the second open end are changed.

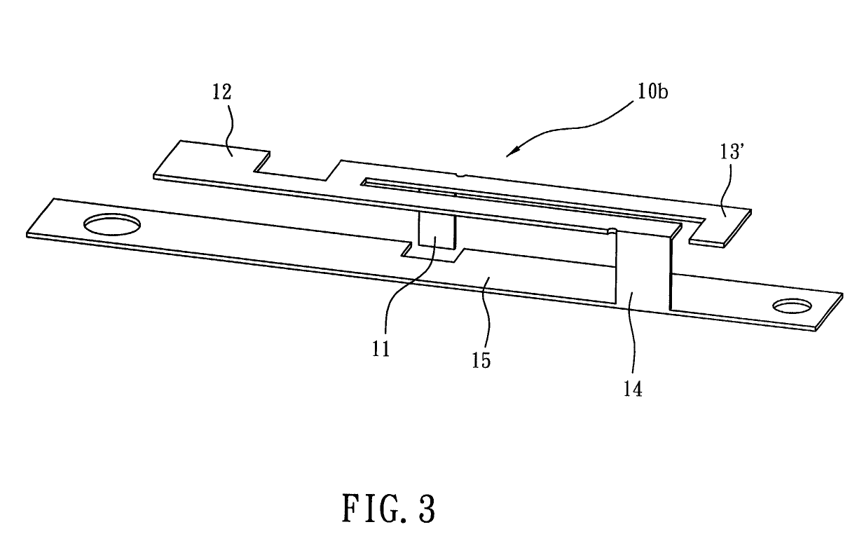

Moreover, as described above, the second open end 13 can have a wider portion to increase the bandwidth of high frequencies (see FIG. 3). The other restrictions of the dual-band inverted-F antenna 10b are the same as FIG. 1.

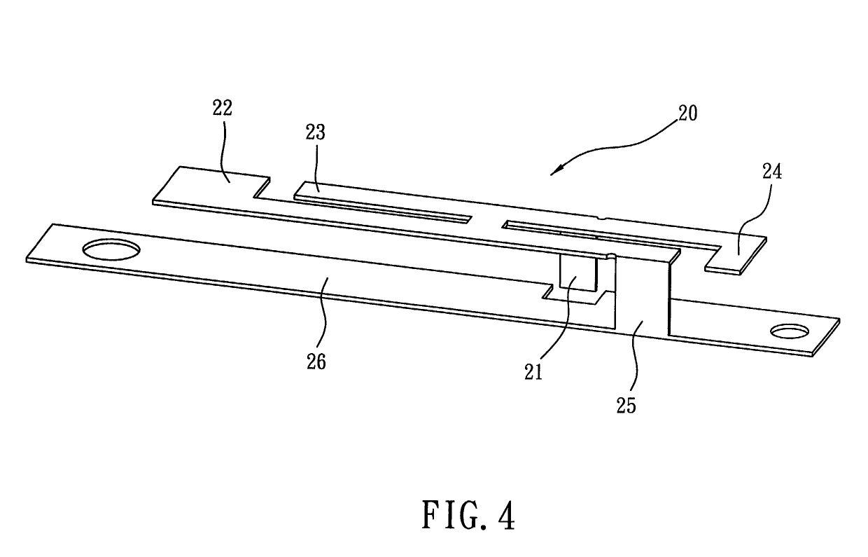

From the above description, a dual-band inverted-F antenna can be readily obtained by the design of the paths from the feed end to the open ends. Analogously, one can utilizes the same design to make multi-band inverted-F antennas. FIG. 4 shows an embodiment of the multi-band inverted-F antenna. Three open ends are used here for three radiation frequencies.

The triple-band inverted-F antenna 20 contains a feed end 21, a first open end 22, a second open end 23, a third open end 24, a short end 25, and a ground 26. The feed end 21 is the connecting point for the signal line. A high frequency signal (voltage) is transmitted from the feed end 21 to the first open end 22, the second open end 23, and the third open end 24. The short end 25 is connected to the ground 26. The signal is finally transmitted through the first open end 22, the second open end 23, and the third open end 24 to the short end 25, then to the ground 26.

In the design, the path length between the first open end 22 and the feed end 21 is ¼ the wavelength of the 2.4 GHz wave (12.5 cm), i.e. about 3˜4 cm. The path length between the second open end 23 and the feed end 21 is ¼ the wavelength of the 5.2 GHz wave (5.8 cm), i.e. about 1.5˜2 cm. The path length between the third open end 24 and the feed end 21 is ¼ the wavelength of the 1.8 GHz wave (16.6 cm), i.e. about 4˜5 cm. Accordingly, when inputting voltage with the corresponding frequencies from the feed end 21, the 2.4 GHz waves are radiated through the first open end 22, the 5.2 GHz waves through the second open end 23, and the 1.8 GHz waves through the third open end 24. Receiving electromagnetic waves with the same frequencies is exactly the reversed process from the above.

In analogy, the open ends can have wider portions to increase the resonance frequency range of the antenna. With regard to the choices in frequencies, one can use such frequencies as 0.9 GHz, 1.6 GHz, 1.8 GHz, 2.0 GHz, 2.4 Gz and 5.2 GHz and design the inverted-F antenna according to the required radiation lengths for these frequencies.

Effects of the Invention

The disclosed inverted-F antenna can be implemented in portable electronic devices such as notebook computers. It is fitted into limited space in the notebook computer and utilizes dual-band or even multi-band radio technology.

Although the invention has been described with reference to specific embodiments, this description is not meant to be construed in a limiting sense. Various modifications of the disclosed embodiments, as well as alternative embodiments will be apparent to persons skilled in the art. It is, therefore, contemplated that the appended claims will cover all modifications that fall within the true scope of the invention.

What is claimed is:

1. An inverted-F antenna designed along a radiation boundary of a notebook computer for receiving and transmitting radio signals, which uses as a dual-band antenna, the antenna comprising:
a feed end, which is connected to a signal source for feeding in two voltage signals;
a short end, which is connected to a ground for outputting the two voltage signals to the ground; and
two radiation paths corresponding to the two voltage signals, respectively, each of which has an open end and a path length from the feed end to its open ends designed according to the frequency of the associated voltage signal, for radiating the corresponding voltage signal and receiving electromagnetic waves with the corresponding frequency, wherein the two voltage signals being transmitted back to the ground through the short end.

2. The inverted-F antenna of claim 1, wherein the areas of the two radiation paths are adjusted to balance their impedance.

3. The inverted-F antenna of claim 1, wherein the areas of the two radiation paths are adjusted to increase their bandwidths.

4. The inverted-F antenna of claim 1, wherein the frequencies of the two voltage signals are selected from the group consisting of 0.9 GHz, 1.6 GHz, 1.8 GHz, 2.0 GHz, 2.4 GHz and 5.2 GHz.

5. A triple-band inverted-F antenna designed along a radiation boundary of a notebook computer for receiving and transmitting radio signals, which uses as a dual-band antenna, the antenna comprising:
a feed end, which is connected to a signal source for feeding in three voltage signals;
a short end, which is connected to a ground for outputting the three voltage signals to the ground; and
three radiation paths corresponding to the three voltage signals, respectively, each of which has an open end and a path length from the feed end to its open ends designed according to the frequency of the associated voltage signal, for radiating the corresponding voltage signal and receiving electromagnetic waves with the corresponding frequency, wherein the three voltage signals being transmitted back to the ground through the short end.

6. The inverted-F antenna of claim 1, wherein the areas of the three radiation paths are adjusted to balance their impedance.

7. The inverted-F antenna of claim 1, wherein the areas of the three radiation paths are adjusted to increase their bandwidths.

8. The inverted-F antenna of claim 1, wherein the frequencies of the three voltage signals are selected from the group consisting of 0.9 GHz, 1.6 GHz, 1.8 GHz, 2.0 GHz, 2.4 GHz and 5.2 GHz.
